(19) United States
(12) Patent Application Publication
(10) Pub. No.: US 2012/0111882 A1
(43) Pub. Date: May 10, 2012

(54) Quick-Access Munitions Pouch

(76) Inventors: Benjamin H. Milligan, Cherry Hill, NJ (US); Samuel Clifford Stokes, Moorestown, NJ (US)

(21) Appl. No.: 13/290,729

(22) Filed: Nov. 7, 2011

Related U.S. Application Data
(60) Provisional application No. 61/410,683, filed on Nov. 5, 2010.

(51) Int. Cl. F42B 39/02; B23P 11/00

(52) U.S. Cl. 221/1; 221/260; 221/151; 29/428

(57) ABSTRACT

Provided are a device, system, and method for storing and/or transporting a munition and then efficiently accessing the stored munition, even when under stressful combat conditions.

### REFERENCE TO RELATED APPLICATION

This application claims priority to U.S. Provisional Application No.: 61/410,683, filed Nov. 5, 2010, which is herein incorporated by reference.

### FIELD OF THE INVENTION

The invention relates to a system, device, and method for quickly accessing a munition stored in a pouch. More particularly, this invention relates to a system and device configured for accessing a munition using only gross motor skills and a method for accessing the munition in a lesser number of steps than those storage pouches currently known in the art.

### BACKGROUND

According to current devices, systems, and methods of storing and accessing an explosive munition when in the field, it is necessary that an operator look at the pouch holding the munition, and then use fine motor skills to grasp the munition in order to remove it from the pouch. The operator must grasp the munition at the most sensitive part of the explosive in order to extract it from the pouch. This procedure presents a problem in situations when an operator's eyes are constantly scanning for threats and dexterity is decreased. Accessing a munition carried in a traditional pouch requires several small steps and each of these steps requires a different fine motor skill, including: using fingertips to unbuckle a buckle, clearing the top of the pouch away using the operator's fingers to see the top of the munition, using the fingertips to grab the top of the munition, and then transferring the munition from the fingertips of one hand to the palm of the other hand. If an internal strap is present to secure the munition, another step is added to this process and forces an operator to wrestle the munition out of the pouch. All operational steps must be performed under stressful, potentially life-threatening, conditions.

Described herein is a quick-access critical weapon system providing quick-access to a munition contained in a storage compartment of the system. Current methods of accessing weapons systems, such as, but not limited to, fragmentation grenades, have several problems: 1) they require fine motor skills; 2) they force an operator to wrestle a munition out of a pouch by the most sensitive part if it became stuck inside the pouch; and 3) they often require an operator to take his eyes off of the immediate surroundings to access the contents of the pouch.

As a result, until the present invention, there remained in the art a need for a device, system, and method for quickly and safely accessing a stored munition using gross motor skills such that the operator would not need to take his eyes off of his surroundings when using the device, system, or method.

### SUMMARY

The present invention is a quick-access munitions pouch, system and method of use that enables an operator to quickly remove munitions enclosed therein. In one embodiment, the quick access-munitions pouch is a pouch having at least a storage compartment with a pouch top opening, a cover flap, a closure assembly, and an ejection strap. The ejection strap has a static end and a gripping end, the static end affixed to an interior portion of the storage compartment of the pouch, and the gripping end extending through the ejection strap exit opening on the pouch. In another embodiment, a system for quickly accessing munitions provides a pouch configured for storing and carrying munitions, a retaining device configured to secure the munitions within the pouch until the munition is ejected therefrom, an operable ejection mechanism for expelling the munitions from the pouch upon active engagement of the ejection mechanism, and a closure means for reversibly affixing the retaining device in a closed position. In another embodiment, a method provides for storing and transporting a munition and then accessing that munition utilizing fewer steps than are currently known for storage and/or transport systems in the art.

The quick-access munitions pouch is especially suited for storing a single munition, such as, but not limited to, an M-67 fragmentation grenade.

The quick-access munition system is constructed to allow an operator using the system to use gross motor skills in a single flowing direction to eject the munition, and to permit the operator to receive and grasp the ejected munition with the palm of the hand around the safest part of the munition without touching the triggering mechanism, while at the same time keeping his eyes on his surroundings, instead of on his equipment.

Additional objects, advantages and novel features of the invention will be set forth in part in the description, examples and figures which follow, and in part will become apparent to those skilled in the art on examination of the following, or may be learned by practice of the invention.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 shows a front view of the quick-access munitions pouch with a munition stored inside the pouch.

FIG. 2 shows a rear view of the quick-access munitions pouch.

FIG. 3 shows a cut-away front view of the quick-access munitions pouch, demonstrating the attachment and orientation of the ejection strap.

FIG. 4 shows a side view of the quick-access munitions pouch with a munition stored inside the pouch.

FIG. 5 shows a side view of the quick-access pouch, with the ejection strap pulled up and away from the pouch, disengaging the securing mechanism.

FIG. 6 shows a side view of the quick-access munitions pouch, once the ejection strap is pulled down, disengaging the closure assembly and ejecting the grenade from the pouch.

### DETAILED DESCRIPTION OF THE INVENTION

For the purposes of the present disclosure, “assisted-access” with reference to the munitions pouch, refers to an assist, in this case by an ejection strap to lift the munition from the pouch. As a result, an operator is assisted by the ejection strap to securely access and remove the munition contained within the pouch.

Regarding the pouch itself, “fabric” means any flexible material or textile, whether natural or man made, fibrous or non-fibrous, elastic or inelastic, or any combination thereof. Fabrics include cloth, cordura, denier-treated cordura, nylon, KEVLAR®, GORE-TEX®, cotton, polyester, or other natural or synthetic fibers, elastomers or polymers. Fabrics also include natural materials such as, but not limited to, leather and suede. Fabrics can be treated for improved strength, durability and flame resistance. Fabrics can be stiffened or made more rigid and less flexible by inclusion of a piece of semi-rigid material (such as, but not limited to, a plastic or other polymer, such as polyethylene, polyvinyl chloride solids) and fixing its location by suitable means including, but not limited to, sewing, gluing, or fusing it in the desired location. However, it is contemplated that other methods of imparting rigidity will be employed, such as, but not limited to, applying an adhesive at the specified location or by other methods well known to those skilled in the art.

“Munitions” means any hand-held explosive weaponry, including but not limited to fragmentation grenades, illuminating grenades, smoke and signaling grenades, chemical grenades, incendiary grenades, offensive grenades, non-lethal grenades, such as “flash-bangs,” training grenades, and the like. “MOLLE” means Modular Lightweight Load-carrying Equipment (MOLLE), which is commonly used for tactical gear, body armor, and other accessories for the Unites States armed forces.

“Tactical gear” means any article configured for modular attachment of accessories and intended to be used, e.g., in combat situations, the articles include, but are not limited to, military gear such as packs, pack frames, gear bags, chest rigs, rifle slings, belts, holsters, vests, jackets, and articles of clothing.

The quick-access munitions pouch is constructed from any one of a number of fabrics known to those skilled in the art to be suitable for the purpose of storing and carrying a munition.

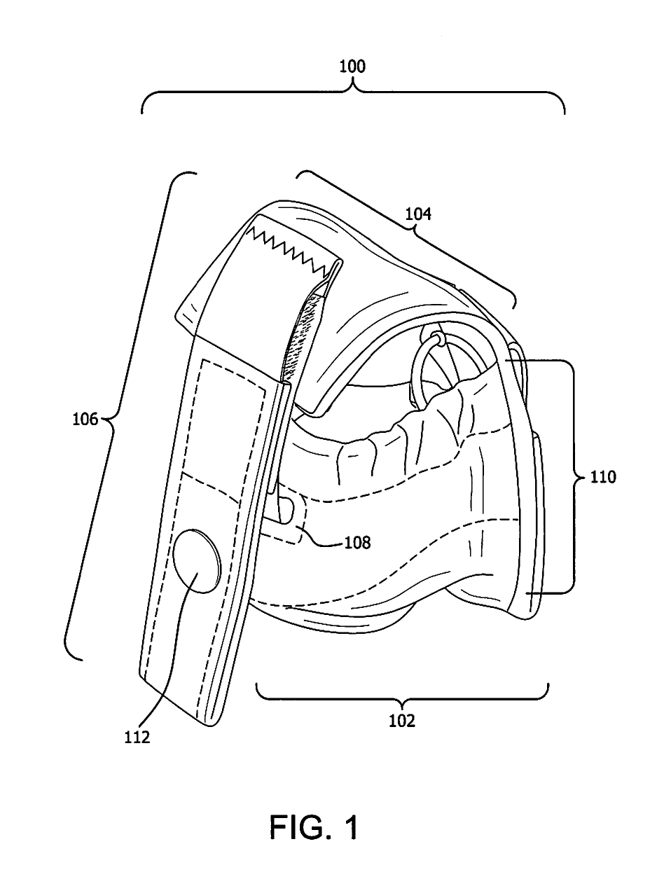

In one embodiment, quick-access munitions pouch 100 is defined by at least three parts: storage compartment 102, cover flap 104, and ejection strap 106. See FIG. 1.

Storage compartment 102 has a surrounding wall 110 which is continuous, or which is divisible into a plurality of quadrants, constructed from individual pieces that are then joined together. The quadrants are identified as including a body-side quadrant, an exterior facing front quadrant, and two lateral quadrants, which when connected, form a continuous pouch, bag, or pouch-type container.

In one embodiment, the pouch is cylindrical in form, having a generally circular cross-sectional conformation. In other embodiments, the pouch has a non-cylindrical form such that the cross-sectional conformation includes, but is not limited to square, rectangular or oval shapes.

Each quadrant of the pouch has two lateral edges at right angles to the top and bottom. These are: a first edge and a second edge. The plurality of quadrants are contiguous with one another and sequentially arranged in a longitudinal manner, such that the second edge of body-side quadrant is connected to the first edge of first lateral quadrant, the second edge of first-lateral quadrant is in turn connected to the first edge of front quadrant, the second edge of front quadrant is in turn connected to the first end of second lateral quadrant, and the second end of second lateral quadrant is then connected to back the first edge of body-side quadrant, thus forming an enclosed cylinder. Further, each quadrant, and the pouch as a whole, has both an interior and an exterior surface. The interior surfaces are connected to and contiguous with one another. Similarly, the exterior surfaces connected to and contiguous with one another.

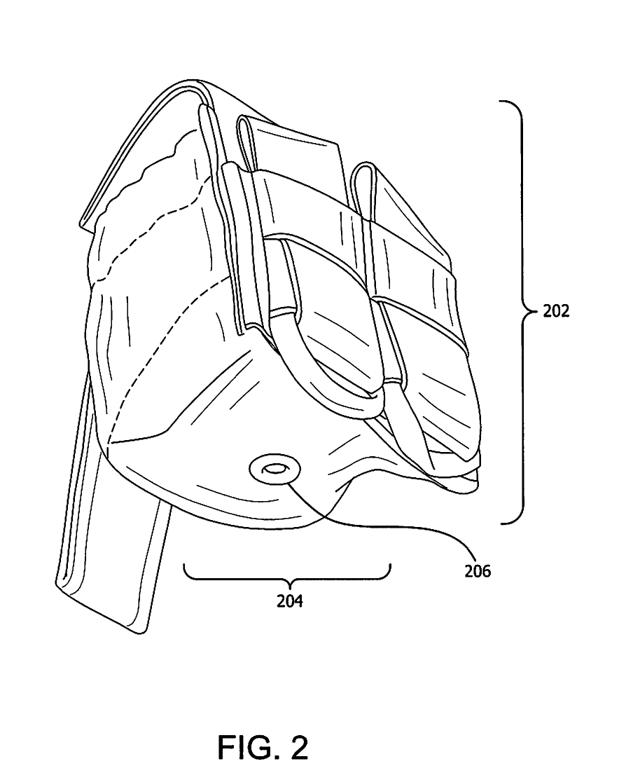

The bottom end of the pouch is completely enclosed, by any of the fabrics identified above. Thus, storage compartment 102 further includes bottom panel 204. The bottom in at least one embodiment is fabric, specifically fabric that is contiguous with the fabric of the sides or wall quadrants. In another embodiment, particularly when the walls comprise quadrants, wherein individual pieces are joined together, the bottom is also a separate, essentially circular piece 204, joined to the bottom-most edge of each quadrant section. In certain embodiments, bottom panel 204 contains a drainage grommet 206. See FIG. 2.

In size, the pouch is of a sufficient length and width, or circumference and height, to completely encompass and enclose the selected munition, but without substantial excess pouch material. The pouch must be of a sufficient size to permit the munition to be easily inserted in its upright position into the pouch, without danger that the munition will fall sideways within the pouch, since in a sideways position the side of the pouch could dangerously chafe or dislodge the trigger end of the munition.

In one embodiment, surrounding wall 110 of storage compartment 102 is made of one or more pieces of fabric. In another embodiment, surrounding wall 110 of storage compartment 102 is made of a single piece of fabric, attached to itself in a generally cylindrical shape. In both embodiments, the top of surrounding wall 110 creates an opening (“pouch top opening”) through which a munition is inserted into or removed from storage compartment 102.

In one embodiment, surrounding wall 110 is further constructed to have a retention webbing, such as, but not limited to, an elastic cord sewn into the top of surrounding wall 110.

Turning to FIG. 2, in one embodiment, attached to the body-side quadrant of the pouch, there is attachment assembly 202 that provides attachment of the pouch to a secondary source. By “secondary source” is meant, for example, a modular system for attaching accessories to another article, such as tactical gear or apparel, including MOLLE-compatible tactical gear and the like. In an alternative, attachment assembly 202 has MOLLE webbing or other suitable means, such as, but not limited to, nylon straps. Additional attachment assemblies include VELCRO®, straps, snaps, or other suitable means of attaching the pouch to the secondary source. See FIG. 2.

As there are several modular systems for tactical gear known to one skilled in the art, although the MOLLE system is specifically identified, the invention is not so limited. With the benefit of the present disclosure, it is anticipated that one skilled in the art could manufacture a quick-access munitions pouch 100 compatible with all known modular tactical gear systems, as well as with any modular tactical gear system to be developed in the future.

The front quadrant of the pouch provides ejection strap exit opening 108, creating a passageway from the interior to the exterior of pouch 100 through surrounding wall 110. The exit opening 108 is of sufficient size to permit passage of the ejector strap 106, which is described in greater detail below.

The munitions pouch 100 further provides a cover flap. In one embodiment, cover flap 104 is constructed of fabric, as listed above. Cover flap 104 connects to and extends from the body-side quadrant of surrounding wall 110 of the pouch.

Cover flap 104 resides in one of two positions: a closed position and an open position. In the closed position, cover flap 104 is folded down as a flap over the top opening of storage compartment 102 of the pouch. In the closed position, cover flap 104 prevents insertion of a munition into or removal of a munition from storage compartment 102. In the open position, cover flap 104 is raised up and away from the opening of storage compartment 102. In the open position, storage compartment 102 is accessible for the insertion or removal of a munition. Cover flap 104 is of sufficient size and dimensions that it fully covers the top opening of storage compartment 102 when cover flap 104 is folded over into the closed position.

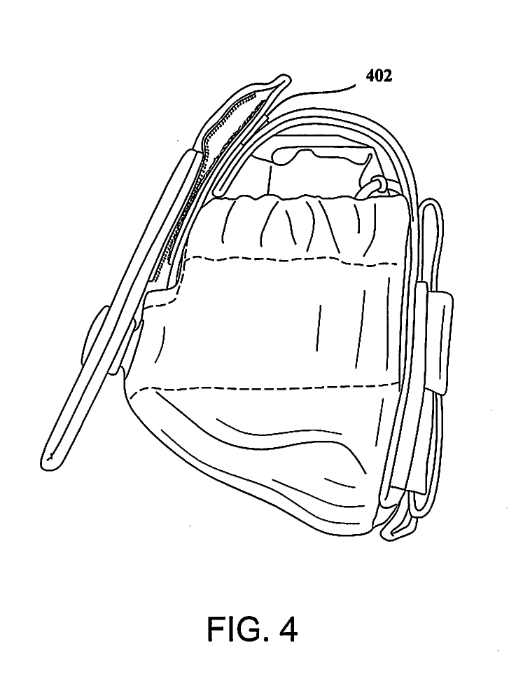

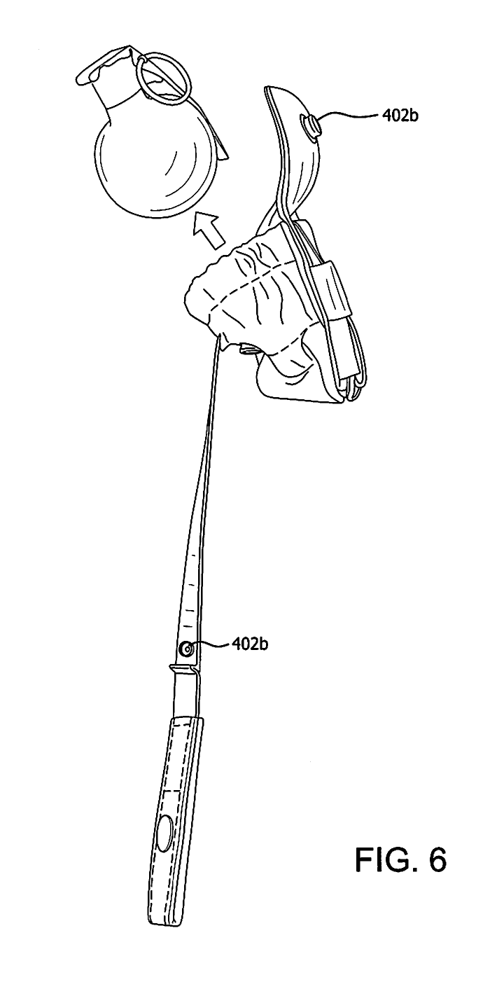

In one embodiment, cover flap 104 contains one part of a two-part, mated closure mechanism 402 configured for reversible engagement of a complementary, mated part, which is located on ejection strap 106. See FIG. 4 and FIG. 6.

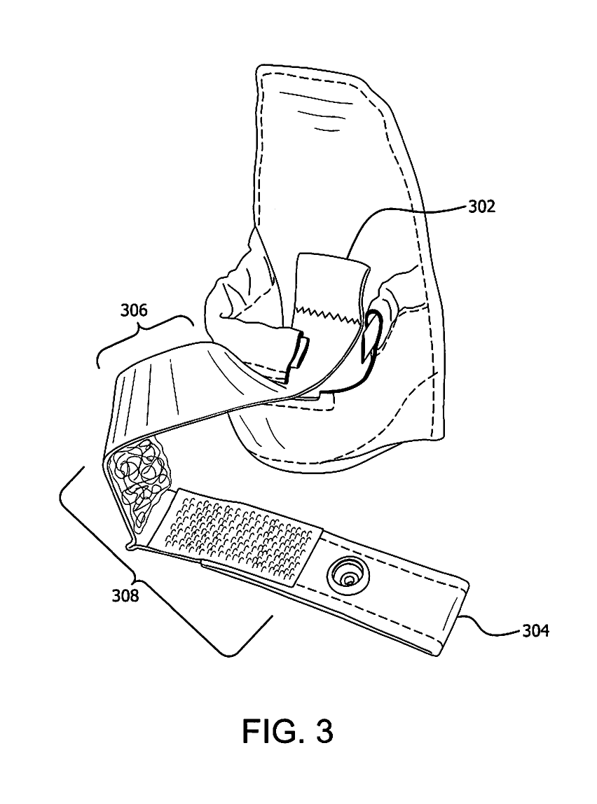

Ejection strap 106 is manufactured from one of any number of materials known to one skilled in the art to be suitable for the purposes of securing a munition in place and also serving as an ejection mechanism. These materials include, but are not limited to fabrics identified above. Ejection strap 106 has two ends: static end 302 and gripping end 304. Additionally, ejection strap 106 has medial section 306, located between the static end 302 and gripping end 304. Ejection strap 106 is wider than it is thick. In addition to static end 302 and gripping end 304, ejection strap 106 also has two side edges: first edge and second edge. See FIG. 3. Ejection strap 106 has two sides: a top side and a bottom side as viewed in the normal orientation when the ejection strap is mounted within the pouch.

In one embodiment, ejection strap 106 is of a minimal length that is longer than the length of storage compartment 102, measured from the top opening to the bottom of storage compartment 102.

Static end 302 of ejection strap 106 is affixed to the interior surface of the body-side quadrant of surrounding wall 110 of the pouch, at a location opposite exit opening 108 of the front quadrant. Static end 302 is affixed to the interior surface of the body-side quadrant by any suitable method or fixable means known to one skilled in the art, including, but not limited to brads, rivets, lacing, gluing, and/or stitching that does not weaken or degrade over time or following use. See FIG. 3. Strength of the seam affixing the ejection strap to the pouch is critical to the effectiveness of the ejection strap, so that it is not pulled away from the pouch in operational use.

In one embodiment, quick-access munitions pouch 100 has one or more closure mechanisms 402. In one embodiment, cover flap 104 does not extend past the opening atop surrounding wall 110 and closure mechanism 402 solely affixes ejection strap 106 to cover flap 104. In another embodiment, cover flap 104 extends beyond opening atop surrounding wall 110 and closure mechanism 402 affixes cover flap 104 to surrounding wall 110, while another closure mechanism 402 affixes ejection strap 106 to cover flap 104.

Ejection strap 106 extends through the pouch's compartment space defined by the internal surfaces of surrounding wall 110, bottom panel 204, and cover flap 104. Ejection strap 106 exits the space through ejection strap exit opening 108 of the front quadrant, such that the gripping end 304 is external to storage compartment 102 of the pouch, while at least a portion of medial section 306 remains within storage compartment 102.

The gripping end 304 of ejection strap 106 further contains one part of a two-part mated closure mechanism 402 configured for reversible engagement with a complementary, mated part. The other mated part of the closure mechanism 402 is located on cover flap 104, such that the mated closure mechanism part of the gripping end 304 is configured for engaging the complementary, mated closure mechanism part on cover flap 104. When the mated closure mechanism part of ejection strap 106 has engaged the complementary, mated closure mechanism part of cover flap 104, cover flap 104 is reversibly affixed in a closed position.

In one embodiment, the mated closure mechanism part of ejection strap 106 is one or more snap members configured for engaging one or more complementary snap members located on cover flap 104. In another embodiment, the mated closure mechanism 402 is a hook-and-loop mechanism. However, although snap members and hook-and-loop mechanisms have been specifically identified, the invention is not so limited. With the benefit of the present disclosure one skilled in the art would be able to use any one of a number of closure mechanisms currently known in the art, as well as any of those which will be developed in the future.

In one embodiment, ejection strap 106 has securing section 308. Securing section 308 has a top side and a bottom side. Securing section 308 contains at least one part of a two-part complementary, mated deployment-prevention mechanism configured for reversible engagement. At least one complementary part of the deployment-prevention mechanism is located on the exterior surface of the front quadrant of pouch 100. When the complementary, mated parts of the deployment-prevention mechanism are operably engaged, ejection strap 106 is secured in a position which prevents accidental operable engagement of ejection strap 106.

In one embodiment, the deployment-prevention mechanism is one or more snap members. In another embodiment, the deployment-prevention mechanism is a hook-and-loop mechanism. In one embodiment, the deployment-prevention mechanism contains a hook-and-loop mechanism to gather excess portions of ejection strap 106 and a snap member to affix the excess portions to the front quadrant. See FIG. 4. However, as above, although snap members and hook-and-loop mechanisms have been specifically identified, the invention is not so limited. With the benefit of the present disclosure, one skilled in the art would be able to use any one of a number of securing mechanisms currently known in the art, as well as any which will developed in the future.

Exemplary Quick-Access Munitions Pouch

In one exemplified embodiment, pouch 100 is entirely composed of synthetic materials, although other embodiments include natural materials or combinations of the two. The exterior surface of the body-side quadrant is configured to be compatible with a MOLLE system for tactical gear.

Ejection strap 106 is affixed to the interior of the body-side quadrant, typically via stitching. Medial section 306 of ejection strap 106 extends in a u-shape within storage compartment 102. More specifically, in operation, the medial section extends in a downward direction along the interior surface of the body-side quadrant, runs across the diameter of bottom panel 204, up the interior surface of the front quadrant, and exits storage compartment 102 via ejection strap exit opening 108.

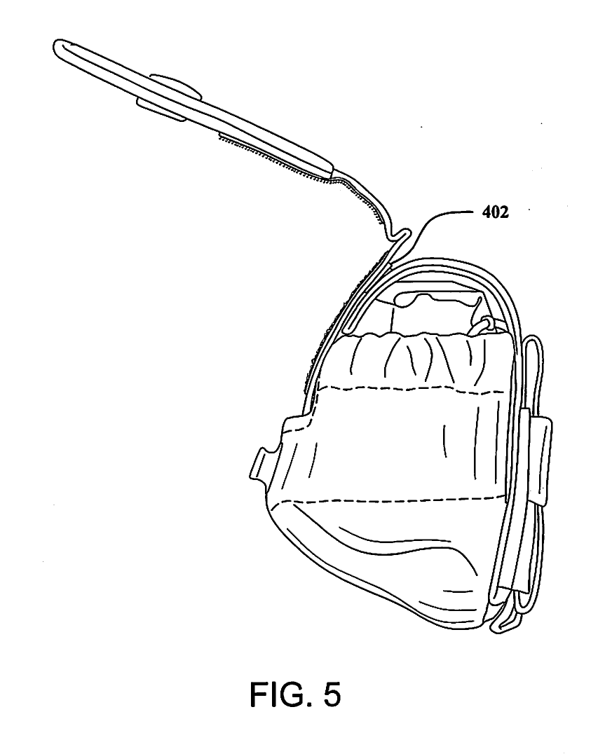

When the pouch in use, a munition is placed within pouch 100, resting atop ejection strap 106, which is deformed into the above-defined u-shape. The bottom side of securing section 308 of ejection strap 106 is configured with a hook section, a loop section, and a deployment-prevention mechanism snap member. The top side of securing section 308 of ejection strap 106 is configured with a closure mechanism snap member. Cover flap 104 and outer surface of the front quadrant are configured with snap members complementary to those of the gripping end 304 of ejection strap 106. The snap member of the top side of ejection strap 106 releasably engages the complementary snap member of cover flap 104. The hook section of the bottom side of the gripping end 304 releasably engages the loop section of the bottom side of the gripping end 304, thereby gathering together the excess strap material. The snap member of the bottom side of ejection strap 106 releasably engages the snap member of the front quadrant. See FIGS. 4-6.

Quick-Access Munitions System

The exemplary quick-access munitions system is defined by at least the following parts: a storage compartment configured for storing and carrying munition, an operable retaining device configured to maintain the munition within pouch 100, an operable ejection mechanism for ejecting the munitions from pouch 100, and an operable closing means for reversibly affixing the retaining device in a closed position. The pouch is constructed of one or more of the above-identified natural or synthetic materials, alone or in mixtures, which materials include, but are not limited to, the above-identifed fabrics.

The quick-access munitions system has a storage compartment configured to hold a munition. Storage compartment 102 is bounded on its sides by surrounding wall and on its bottom by bottom panel 204, as described above. The top of storage compartment 102 is open, allowing for insertion or removal of a munition. In one embodiment, storage compartment 102 also has a retention webbing. The retention webbing is one of any number of materials known in the art, including, but not limited to, an elastic band sewn into surrounding wall 110 at the top of storage compartment or a cord configured to be tightened and thus draw portions of surrounding wall 110 in and around the munition.

The quick-access munitions system also has an operable retaining device configured to reversibly retain the munition in storage compartment 102. In one embodiment, the operable retaining device is a cover flap made of a flexible material, including but not limited the above-identified fabrics. The flexible nature of cover flap 104 allows for cover flap 104 to be reversibly placed over the opening of storage compartment 102. As described above, cover flap 104 resides in one of two positions: a closed position or an open position. In the closed position, cover flap 104 is placed over the opening of storage compartment 102. With the cover flap closed, a munition cannot be removed from storage compartment 102, nor can a munition be added to storage compartment 102.

In the open position, cover flap 104 is lifted away from the opening of storage compartment 102. In this position, the interior of storage compartment 102 is accessible, allowing a munition to be inserted into or removed from storage compartment 102. Although the retaining device is described in the form of a fabric cover flap, the invention is not so limited. With the benefit of the present disclosure, one in the art could contemplate and make use of any one of a number of retaining devices known to be configured for reversibly retaining an item in a specific location, as well as any such devices which will be developed in the future.

The quick-access munitions system also provides an operable ejection mechanism. The ejection mechanism has at least two positions: a pre-ejection position, also known as a “storing position,” which is suitable for transport and/or storage, and a post-ejection position. The ejection mechanism requires an operator to actively engage it in order to eject the munition, in that the ejection strap component must be pulled to activate. In one embodiment, the ejection mechanism is an ejection strap having two ends, one of which is affixed to a location on the interior surface of the body-side quadrant of storage compartment 102. The ejection mechanism is made of a flexible material, configured to be deformed into a storing position as well as extended into a post-ejection position. When in the storing position, the ejection mechanism is deformed into an approximately u-shaped figure as described above. One end of the ejection mechanism is affixed to an interior location of pouch 100. The strap then extends in a downward direction along the interior surface of the body-side quadrant of storage compartment 102, runs across bottom panel 204 of storage compartment 102, then extends upwards along the interior surface of the front quadrant of storage compartment 102, and exits through ejection strap exit opening 108 to the exterior of storage compartment 102. When the ejection mechanism is thus deformed in storage compartment 102, i.e., in the storing position, a munition may be placed in storage compartment 102 atop the ejection strap 106 within the pouch, establishing the ejection mechanism of the present invention.

The ejection mechanism is also configured to have a post-ejection position. In the post-ejection position, the ejection mechanism has been pulled through the ejection strap exit opening, and is in a generally straight conformation, with most of the strap now being exterior to storage compartment 102, with only a small portion of the strap near where it is affixed to the pouch remaining on the interior of storage compartment 102.

Thus, the ejection mechanism is configured for reversible movement from a storing position to a post-ejection position upon active engagement by the operator. Engagement of the ejection mechanism from the storing position to the post-ejection position requires that the ejection mechanism manually be pulled from a deformed shape to a generally straight shape. When the ejection mechanism is pulled up to an extended, post-ejection position, a portion of the ejection mechanism is raised from a storing position location near bottom panel 204 of storage compartment 102 beneath the munition when a munition is placed within the pouch. When a munition is in place atop the ejection mechanism, the munition is lifted to the top opening of the pouch as the ejection mechanism is pulled from its location near bottom panel 204, and raises up to the level of the ejection strap exit opening on the pouch.

The rising ejection mechanism forces the munition towards the opening of storage compartment 102, such that when the ejection mechanism reaches its post-ejection position; the munition is fully raised and is positioned to be grasped at least partially above the top opening of storage compartment 102. Further, the operation of the ejection mechanism compresses the lower portion of storage compartment 102, while simultaneously raising the munition towards the top of storage compartment 102; resulting in greater access to the munition once the ejection mechanism has reached the post-ejection position. This increased access position advantageously permits an operator using the pouch to manually quickly and efficiently grasp the ejected munition without requiring fine motor skills, and then to immediately operate the munition, if so desired.

The quick-access munitions system also has an operable closing means for reversibly affixing the operable retaining device in a closed position. In one embodiment, the closing means is two-part closure mechanism 402 described above, including, but not limited to, snap members or a hook-and-loop system. As has also been described, one part of the two-part closure mechanism 402 is affixed to the operable retaining device. A complementary, mated part of closure mechanism 402 is affixed to the ejection mechanism. Thus, the complementary, mated parts of the closure means are configured for reversible engagement, wherein when connected, the parts of closure mechanism 402 maintain the retaining device in a closed position. However, when closure mechanism 402 is disengaged, the retaining device is released and free to move to the open position.

In one embodiment, the quick-access munitions system also includes an operable deployment-prevention mechanism configured to prevent accidental engagement of the ejection mechanism. The operable deployment-mechanism includes one or more securing mechanisms. In one embodiment, the securing mechanism is a snap member having two complementary, mated parts configured for reversible engagement. One of the complementary, mated parts of the deployment-prevention mechanism is located on the exterior surface of the front quadrant of storage compartment 102. The complementary, mated part of the deployment-prevention mechanism is located on the ejection mechanism, such that when the two parts of the deployment-prevention mechanism are operably engaged and connected to one another, the end of the ejection mechanism is temporarily held in a fixed position on the exterior surface of storage compartment 102. Therefore, the operator must disengage the deployment-prevention mechanism before being able to disengage closure mechanism 402 and correspondingly actively engage the ejection mechanism. This prevents, or at least reduces, accidental ejection of the munition. In an alternative embodiment, the deployment-prevention mechanism is similarly achieved using a hook-and-loop system for gathering excess portions of the ejection mechanism together and a snap member for affixing the excess portion of the ejection mechanism to the exterior of storage compartment 102.

In one embodiment quick-access munitions system also includes an operable attachment means for reversibly attaching the quick-access munitions system to a modular, tactical apparel system. In one embodiment, the attachment means is MOLLE-compatible. Although the MOLLE system has herein been identified, the invention is not so limited. With the benefit of the present disclosure, one skilled in the art would be able to adapt any one of a number of presently-known modular attachment means for use in combination with the invention. Similarly, it is anticipated that as future modular attachment means are developed, one skilled in the art will be able to adapt them for use with the invention.

Although the present invention has been described in embodiments wherein the pouch comprised a single storage compartment configured to hold a single munition, with the benefit of the present disclosure, one skilled in the art will also be able to construct a divided pouch with a plurality of separated interior storage compartments, cover flaps, and ejection straps, such that multiple munitions may be stored within the pouch, each of which may be accessed and indepently ejected.

Exemplary Quick-Access System

In one embodiment, the quick-access munitions system comprises pouch 100, an operable retaining device, an operable ejection mechanism, an operable closure means, an operable deployment-prevention mechanism, and an operable attachment mechanism. Pouch 100 is configured to store and/or carry a munition. The operable retaining device is a cover flap attached to pouch 100, configured to reversibly transition from a closed position, whereby the flap prevents the munition from being removed from or inserted into pouch 100, to an open position wherein a munition may be removed from or inserted into pouch 100. The operable ejection mechanism is the above disclosed ejection strap, affixed to the interior surface of the body-side quadrant of pouch 100, and configured for reversible transition from a deformed, storing position to an elongated, post-ejection position. In moving from the storing position to the post-ejection position, ejection strap 106 simultaneously lifts the munition to the top opening of pouch 100 while also compressing the bottom of pouch 100. The operable closure means is a two-part, complementary, mated snap member that is configured for reversible engagement. One part of the closure means is mounted on ejection strap 106, and the complementary, mated part of the closure means is mounted on the operable retaining device. The operable deployment-prevention mechanism also has, e.g., a hook-and-loop system for gathering excess portions of ejection strap 106, and another two-part, complementary, reversibly mated snap member system. However, in this case, one part of the snap member system is located on securing section 308 of ejection strap 106, while the complementary, mated part of the snap member system is located on the exterior surface of the front quadrant of pouch 100, as is described in greater detail above.

Method for Storing/Transporting and Quickly Accessing a Munition

An exemplary method is disclosed for storing and/or transporting a munition and also for quickly and efficiently accessing the stored and/or transported munition. The method is repeated for additional munitions, each in an individual pouch on the secondary source, as such carriers are defined above. The method of loading a munition into the pouch comprises at least the following steps: 1) opening the quick access munitions pouch of the present invention and 2) loading the munition into the pouch so that it rests on top of the ejection strap within the pouch. In this method the above disclosed ejection strap 106 is affixed and positioned within the pouch, such that the strap extends downward from the point of attachment and rests on the bottom of the pouch, and then extends upward inside of the front of the pouch. The gripping end 304 of strap 106 exits the pouch through ejection strap exit opening 108.

Loading step (2) above further provides a step of placing the munition so that it lays in an upright position on top of that portion of ejection strap 106 that rests on the bottom of pouch 100. It is, therefore, critical before loading a munition into the pouch, that ejection strap 106 is of a sufficient length to be deformed into a storing position under the stored munition within the pouch. There must also be enough remaining length of ejection strap 106 to extend the gripping end 304 through ejection strap exit opening 108 of pouch 100.

After placing the munition into pouch 100 atop ejection strap and deforming it, the next step provides moving cover flap 104 over the top opening of quick-access munitions pouch 100. This step is followed by engaging the closure assembly so that cover flap 104 and the pouch 100 are held in the closed position, until it is intentionally re-opened to extract or eject the munition.

The method for ejecting the munition from the pouch is also provided by pulling gripping end 304 of ejection strap 106 downward and/or outward from the pouch, lifting the munition up and out of the pouch opening. This simultaneously causes disengaging of closure mechanism 402, while at the same time compressing the lower portion of pouch 100. This method of ejection permits an operator of the quick release munitions pouch to pull the ejection strap with one hand, leaving the other hand free for efficiently retrieving the ejected munition without touching the triggering mechanism of the munition.

Once the munition has been loaded into pouch 100, at no point does the operator manipulate the munition at its sensitive points, nor does the operator use any fine motor skills to unbuckle anything or to grab a small tab of webbing to raise, or elevate, the munition out of pouch 100. Ejection strap 106 is grabbed by the whole hand and pulled to access the munition stored in pouch 100.

In certain embodiments, the method further includes the step of disengaging a deployment-prevention mechanism prior to disengaging closure mechanism 402. For example, this step is accomplished by first grasping gripping end 304 and pulling ejection strap 106 in an upward manner. The upward pull disengages the deployment-prevention mechanism, and the movement is immediately followed by the downward pull required to disengage closure mechanism 402 and engage the ejection properties of ejection strap 106. In this manner, ejection is effected via a two-pull method.

These method steps of the present invention for quickly accessing the munition, advantageously allow an operator to use gross, instead of fine, motor skills when accessing the munition in a directional/flowing single movement away from the body. The result is much faster access to a critical weapon system that can become difficult to access in the heat of combat when an operator's fine motor skills are less reliable. The use of the present system allows an operator to access life-saving weapon systems faster and more reliably than prior art pouches because the ejection and retrieval of the munition from quick-access pouch 100 is completed with a requirement for only gross motor skills, and requiring fewer steps than previously known methods in the art.

While the foregoing specification has been described with regard to certain preferred embodiments, and many details have been set forth for the purpose of illustration, it will be apparent to those skilled in the art that the invention may be subject to various modifications and additional embodiments, and that certain of the details described herein can be varied considerably without departing from the spirit and scope of the invention. Such modifications, equivalent variations and additional embodiments are also intended to fall within the scope of the appended claims.

What is claimed is:

1. An assisted-access munitions pouch, comprising:
a storage compartment having an interior area of a size sufficient to completely contain the munition without excess fabric bulk, the compartment having an enclosed bottom, and a top opening of a size greater than the width of the munition, and an ejection strap opening;
a cover flap, constructed to reversibly cover the top opening;
an ejection strap comprising two ends, a static end and a gripping end; and
a pouch closure assembly.

2. The assisted-access munitions pouch of claim 1, wherein the static end of the ejection strap is affixed to a wall inside the storage compartment, and the gripping end of the ejection strap exits the storage compartment pouch through the ejection strap opening, which is on a wall opposite the static end affixment.

3. The assisted-access munitions pouch of claim 2, further comprising between the static end affixment and the ejection strap opening, the ejection strap extended within and across the width of the storage compartment, resting on the bottom of the storage compartment without excess.

4. The assisted-access munitions pouch of claim 1, wherein the pouch closure assembly further comprises a two part closure device, having a first closure part affixed to the cover flap, reversibly mated to a second closure part affixed to the gripping end of the ejection strap.

5. The assisted-access munitions pouch of claim 1, further comprising a deployment-prevention mechanism.

6. The assisted-access munitions pouch of claim 5, wherein the deployment-prevention mechanism further comprises at least one two part mechanism, having a first deployment-prevention mechanism part reversibly mated to a second deployment-prevention mechanism part.

7. The assisted-access munitions pouch of claim 6, wherein the first deployment-prevention mechanism part is affixed to the pouch on an exterior side proximate to the ejection strap opening, and the second deployment-prevention mechanism part is affixed to the gripping end of the ejection strap.

8. The assisted-access munitions pouch of claim 1, wherein the pouch is functionally affixed to a secondary source, directly or by a secondary source attachment assembly.

9. The assisted-access munitions pouch of claim 8, wherein the secondary source attachment assembly is MOLLE-compatible.

10. A system for assisted-access to a munition, comprising:
a pouch comprising a storage compartment having an interior area of a size sufficient to completely contain the munition without excess fabric bulk, the compartment having an enclosed bottom, and a top opening of a size greater than the width of the munition, and an ejection strap opening;
a cover flap, constructed to reversibly cover the top opening and prevent unintended ejection of the munition;
an ejection strap comprising two ends, a static end and a gripping end for operably lifting the munition; and
a functionally reversible pouch closure assembly.

11. The system for assisted-access to a munition of claim 10, wherein the static end of the ejection strap is affixed to a wall inside the storage compartment, and the gripping end of the ejection strap exits the storage compartment pouch through the ejection strap opening, which is on a wall opposite the static end affixment.

12. The system for assisted-access to a munition of claim 11, further comprising between the static end affixment and the ejection strap opening, the ejection strap extended within and across the width of the storage compartment, resting on the bottom of the storage compartment without excess.

13. The system for assisted-access to a munition of claim 10, wherein the pouch closure assembly further comprises a two part closure device, having a first closure part affixed to the cover flap, reversibly mated to a second closure part affixed to the gripping end of the ejection strap, configured in the open position to permit access to the munition, and in the closed position to prevent deployment of the munition.

14. The assisted-access munitions system of claim 10, further comprising a deployment-prevention mechanism.

15. The assisted-access munitions system of claim 14, wherein the deployment-prevention mechanism further comprises at least one two part mechanism, having a first deployment-prevention mechanism part reversibly mated to a second deployment-prevention mechanism part, configured to operably prevent accidental engagement of the ejection strap.

16. A method for ejecting a munition stored in the assisted-access munitions pouch of claim 1, the method comprising:
pulling down on the gripping end of the ejection strap, thereby disengaging the closure assembly, and
continuing to pull down on the ejection strap, thereby propelling the munition upward towards the cover flap, causing the munition to extend from the top opening of the storage compartment of the pouch, and to simultaneously compress a bottom portion of the storage compartment of the pouch, thereby
ejecting at least a portion of the contained munition from the top opening of the storage compartment of the pouch, and
permitting the munition to be grasped from the pouch.

17. A method for loading a munition into the assisted-access munitions pouch of claim 3, the method comprising:
placing the munition in an upright position within the storage compartment of the pouch, with the munition base resting on the ejection strap extended within and across the width of the storage compartment, wherein the strap is resting on the bottom of the storage compartment without excess.
